(19) United States
(12) Patent Application Publication
(10) Pub. No.: US 2015/0349342 A1
(43) Pub. Date: Dec. 3, 2015

(54) REDOX BATTERY USE FOR POLYOXOMETALLATE

(71) Applicant: ACAL ENERGY LIMITED, Cheshire (GB)

(72) Inventors: Andrew Martin Creeth, Cheshire (GB); Nicholas de Brissac Baynes, Cheshire (GB); Joshua Denne, Cheshire (GB)

(21) Appl. No.: 14/409,453

(22) PCT Filed: Jun. 25, 2013
(86) PCT No.: PCT/GB2013/051676

§ 371 Date: Dec. 18, 2014

(30) Foreign Application Priority Data
Jun. 26, 2012 (GB) 1211349.4

(51) Int. Cl. H01M 4/58; C01G 41/00; C01B 25/45; C01G 39/00; H01M 8/18; H01M 8/20

(52) U.S. Cl. CPC H01M 4/5825; H01M 8/188; H01M 8/20; C01B 25/45; C01G 39/006; C01G 41/006

(57) ABSTRACT

The present invention provides a redox battery comprising a polyoxometallate as at least one redox couple. Preferably, the redox battery comprises two electrodes separated by an ion exchange membrane or other separator; means for supplying a first redox couple to the first electrode region of the cell; means for supplying a second redox couple to the second electrode region of the cell, the potential of the first redox couple being higher than that of the second redox couple, and at least the higher potential redox couple comprising polyoxometallate.

The present invention relates to a redox battery comprising a polyoxometallate as a redox couple. Also provided is the use of a polyoxometallate as a redox couple in a redox battery, a polyoxometallate for use as a redox couple in a redox battery and a redox battery stack comprising the redox batteries described herein.

Redox batteries are well known in the art and have a wide range of applications. Generally, a redox battery comprises an energy converter, comprising an electrochemical cell with two electrodes separated by an ion exchange membrane or other separator, as well as a chemical store of energy comprising two redox couples located on either side of the membrane, one at a low redox potential and the other at a high redox potential. The chemical store and the converter can be sized separately and the two redox couples are stored in vessels away from the converter.

A commonly known redox battery is the vanadium redox battery. The present form of vanadium redox battery, which uses sulphuric acid electrolytes, was patented in 1986. This battery exploits the ability of vanadium to exist in solution in four different oxidation states. On one side of the membrane, VO²⁺ is converted to VO₂⁺ as electrons are removed from the positive electrode during charging. On the other side, V³⁺ is converted into V²⁺ on the introduction of electrons from the negative electrode. During discharge, this process is reversed, resulting in an open circuit voltage of 1.41V at 25° C. The electrodes are generally an inert material, such as graphite, or porous metal electrodes such as titanium, which are coated with carbon. Both half cells are additionally connected to storage tanks and pumps so that very large volumes of the electrolytes can be circulated through the cell.

The circulation of the electrolytes and the pumps required to implement it mean that vanadium batteries are generally restricted to large fixed installations and are not generally used in mobile applications. However, such batteries can offer an almost unlimited capacity by increasing the storage tank volume. Further, if the electrolytes are accidentally mixed, the battery suffers no permanent damage. Vanadium batteries can also be left discharged for a prolonged period of time with little ill-effects and can easily be recharged by replacing the electrolyte or by electrochemically recharging the electrolyte. They can also respond quickly to changes in power requirements and can be discharged and recharged many times without damaging the electrode.

The large capacity and size of vanadium redox batteries therefore means that they are used in applications such as averaging out the production of highly variable energy generation sources such as wind or solar power, or to help generators cope with large surges in demand. They are also suitable for applications in which the batteries must be stored for long periods of time with little maintenance, such as in some military electronics applications.

The key features of redox batteries are the relative costs and efficiencies. Typically, the charge/discharge efficiency is required to be above 75%. The main costs are due to the converter (which scales with the power input/output) and the couple chemistries (which scale with the energy storage).

The cost per power output/input is dictated by the current density of the redox battery. Losses in the cell dictate the magnitude of the current density and need to be kept as small as possible in order to maintain an acceptable overall charge/discharge efficiency.

It is desirable to have the potentials of the couples as far apart as possible to maximise the energy store. Further, it is also desirable to have the redox couple concentrations as high as possible so as to reduce losses from pumping.

However, this requires the couples to have rapid electrode kinetics, as well as requiring that losses such as those from resistances in the cell components and the electrolyte are as low as possible. In order to do this, current densities are typically kept low, thereby reducing the power density so that, by comparison with a fuel cell, a large (and therefore expensive) converter unit is required. Vanadium redox batteries therefore have a relatively low energy-to-volume ratio, as well as a more complex structure than other batteries known in the art.

Vanadium batteries are also limited in concentration and temperature range by the insolubility of the various species used. Again, this limits the efficiency of the operation of the system, meaning that a larger and more costly energy converter is required.

Typically, the membranes used in redox batteries of the prior art are cationic exchange membranes, which allow hydrogen ions to pass through them, thereby completing the circuit. Such membranes are not totally selective and there is a discharge of ions across the membrane which must be corrected on an occasional basis. The vanadium redox battery does have an advantage over other redox batteries, as the ions are similar on both sides of the membrane. However, the crossover of vanadium species through the membrane represents a self-discharge with the associated loss of efficiency.

It would therefore be advantageous to have a redox couple where the ions are large and negatively charged. Such ions would therefore be excluded from the membrane by the Donan principle and strongly inhibited from crossing the membrane. A further requirement would be for redox couples with electrode kinetics that are as rapid as possible and therefore are as reversible as possible, as well as for redox couples that are able to operate at high temperatures and concentrations.

Accordingly, a first aspect of the present invention involves a redox battery comprising a polyoxometallate as at least one of the redox couples.

The redox battery in accordance with the invention preferably comprises two electrodes separated by an ion exchange membrane or other separator; means for supplying a first redox couple to the first electrode region of the cell; means for supplying a second redox couple to the second electrode region of the cell, the potential of the first redox couple being higher than that of the second redox couple, with at least the higher potential redox couple comprising polyoxometallate.

In an embodiment of the present invention, the polyoxometallate is in the form of a large structure, wherein the polyoxometallate is substantially rejected from the membrane or other separator by means of charge and/or size, so as to be substantially prevented from flowing through the ion exchange membrane or other separator. Preferably, the large structure is a Keggin ion. Keggin ions are large, anionic structures that are repelled by the membranes used in redox batteries. The use of such structures therefore helps to prevent the discharge of ions across the membrane. Another such structure is the bi-nuclear Dawson-Wells structure, typically containing two central atoms and 18 metal centres. Several other more complex structures are also known in the art.

The polyoxometallate system of the present invention is also less corrosive than the standard vanadium systems, which include acids such as sulphuric acid. For example, one commonly used vanadium system includes a mixture of sulphuric and hydrochloric acids which is much more corrosive than the polyoxometallate solution of the present invention.

In a further embodiment, at least the polyoxometallate redox couple is provided in aqueous solution.

It has surprisingly been found that the electrode kinetics resulting from the use of a polyoxometallate in a redox battery are much more reversible than the corresponding vanadium species. Preferably, the current density of operation is significantly higher than the standard for a vanadium redox battery.

In one embodiment, the low potential redox couple comprises a low potential polyoxometallate such as a tungsten polyoxometallate. Preferably, the structure of the tungsten polyoxometallate is HₓW₁₂KO₄₀, where K is for example, P, Si, B or Co, preferably Si, B or Co. In another embodiment, the low potential redox couple comprises vanadium (II) and vanadium (III) ions.

The polyoxometallate solution for use in the redox battery may be non stoichiometric. In one embodiment, the high potential polyoxometallate is a vanadium polyoxometallate. Accordingly, in another embodiment of the invention, vanadium ions can be added to the polyoxometallate solution in the form of at least one vanadium compound selected from VO₂, V₂O₄, VOSO₄, VO(acac)₂, VO(ClO₄)₂, VO(BF₄)₂, hydrated versions thereof, and combinations of two or more thereof.

In a further embodiment of the present invention, the high potential polyoxometallate is present at lower concentrations, in combination with another source of vanadium, as outlined above. Preferably, the POM is at concentrations of less than 0.075 M by the central atom. The vanadium concentration can be 0.075 M or greater, greater than 0.5 M, greater than or equal to 1 M or equal to 2M.

Preferably, the molar ratio between the high potential polyoxometallate and the vanadium compound is at least about 1:10 or at least about 1.5:10 or at least about 2:10 or at least about 2.5:10 or at least about 3:10. In a specific embodiment, VOSO₄ is added in the concentration range of 0.5 to 2M.

The polyoxometallate may be represented by the formula:

Xₐ[Z_{b}M_{c}O_{d}]

Wherein X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M is a metal selected from Mo, W, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series, and combinations of two or more thereof;
a is a number of X necessary to charge balance the [M_{c}O_{d}] anion;
b is from 0 to 20;
c is from 1 to 40; and
d is from 1 to 180.

It is to be understood that such formulae used herein are generic formulae and that a distribution of related species may exist in solution.

Generally, if M does not include vanadium then the polyoxometallate is a low potential redox couple. If M comprises at least one vanadium species then the polyoxometallate is a high potential redox couple. It should also be understood that any numerical values are not necessarily integers.

Preferred ranges for b are from 0 to 15, more preferably 0 to 10, still more preferably 0 to 5, even more preferably 0 to 3, and most preferably 0 to 2.

Preferred ranges for c are from 5 to 20, more preferably from 10 to 18, and most preferably 12.

Preferred ranges for d are from 30 to 70, more preferably 34 to 62, and most preferably 34 to 40.

Vanadium or combinations of vanadium and molybdenum are particularly preferred for M of the high potential polyoxometallate.

Phosphorus is particularly preferred for the central atom, Z.

A combination of hydrogen and an alkali metal and/or alkaline earth metal is particularly preferred for X. One such preferred combination is hydrogen and sodium.

Specific examples of polyoxometallates include molybdovanadophosphosphoric acid (H₅PMo₁₀V₂O₄₀), which would act as the high potential polyoxometallate and molybdophosphoric acid (H₃PMo₁₂O₄₀).

In a preferred embodiment of the present invention, the high potential polyoxometallate comprises vanadium, more preferably vanadium and molybdenum. Preferably the polyoxometallate comprises from 1 to 6 vanadium centres. Thus, particularly preferred polyoxometallates include H₃Na₂PMo₁₀V₂O₄₀, H₃Na₃PMo₉V₃O₄₀, or H₃Na₄PMo₈V₄O₄₀ and compounds of intermediate composition. In addition, a mixture of these or other polyoxometallate species is also envisaged. For this embodiment, preferably, at least one X is hydrogen. For a further embodiment, X comprising at least one hydrogen and at least one other material selected from alkali metals, alkaline earth metals, ammonium and combinations of two or more thereof is preferred.

Alternatively, the high and low potential redox couples can have the same formulation but just be in different redox states, thereby preventing contamination from cross-over.

Other polyoxometallates useful in the redox battery of the invention may be represented by the formula:

Xₐ[Z_{b}M_{c}O_{d}]

Wherein X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M comprises W and optionally one or more of Mo, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series;
a is a number of X necessary to charge balance the [Z_{b}M_{c}O_{d}]^{a-} anion;
b is from 0 to 5;
c is from 5 to 30; and
d is from 1 to 180.

The use of tungsten in the polyoxometallate compound compared to the use of the other compounds disclosed in the prior art has numerous benefits. It has been found that the tungsten polyoxometallates are more stable at low pH and can be synthetically manipulated to a greater extent than molybdenum analogues. It is therefore possible to create a variety of different structures that are not available when using other polyoxometallate compounds, such as those containing molybdenum, and to use a wider range of materials.

Further, some compositions of polyoxometallates known in the prior art can have a lower solubility than is desired for maximum redox battery performance. It has surprisingly been found that solubility can be improved by using tungsten polyoxometallate redox couples. The tungsten polyoxometallates of the present invention also provide excellent electrochemical performance.

Preferred ranges for b are from 0 to 5, more preferably 0 to 2.

Preferred ranges for c are from 5 to 30, preferably from 10 to 18 and most preferably 12.

Preferred ranges for d are from 1 to 180, preferably from 30 to 70, more preferably 34 to 62 and most preferably 34 to 40.

The high potential polyoxometallate according to the above formula useful as the redox couple in the redox battery of the present invention preferably contains from 1 to 6 vanadium centres. Example formulae therefore include Xₐ[Z₁W₁₂₋ₓVₓO₄₀] where x=1 to 6. In one embodiment of the present invention, the polyoxometallate has the formula Xₐ[Z₁W₉V₃O₄₀]. In another embodiment, the polyoxometallate has the formula Xₐ[Z₁W₁₁V₁O₄₀].

B, P, S, As, Si, Ge, Al, Co, Mn or Se are particularly preferred for Z, with P, S, Si, Al or Co being most preferred. The successful use of such a range of atoms would not be possible with a polyoxometallate that contains, for example, molybdenum, as outlined in the prior art. In particular, the use of silicon and aluminium in combination with tungsten in the polyoxometallates of the present invention has surprisingly been shown to significantly improve the performance of the fuel cells. For example, tungsten polyoxometallates with aluminium or silicon demonstrate more reversible electrochemical properties at a higher potential compared to certain other polyoxometallates.

M may consist of 1 to 3 different elements. In one embodiment, M is a combination of tungsten, vanadium and/or molybdenum. The polyoxometallate may be absent of molybdenum and further may be absent of any metals other than tungsten or vanadium. The polyoxometallate may alternatively consist of tungsten. M preferably includes more than two, more than four or more than six tungsten atoms.

Hydrogen, or a combination of hydrogen and an alkali metal and/or alkaline earth metal are particularly preferred examples for X. X preferably comprises a hydrogen ion or a combination of a hydrogen ion and an alkali metal ion, and more preferably comprises one or more of H⁺, Na⁺, K⁺ or Li⁺. Preferred combinations include hydrogen, hydrogen with sodium and hydrogen with potassium.

In a preferred embodiment, the high potential polyoxometallate may be H₆[AlW₁₁V₁O₄₀]. Alternatively the high potential polyoxometallate may be X₇[SiW₉V₃O₄₀] where, as an example, X can give rise to the general formula K₂H₅[SiW₉V₃O₄₀]. Further, a mixture of these or other polyoxometallate catalysts is als envisaged.

The high potential polyoxometallate for use in the present invention may also be represented by the formula:

XₐV_{y}Q_{12-y}ZO₄₀

wherein X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
Q is selected Mo or W;
a is a number of X necessary to charge balance the [V_{y}Q_{12-y}ZO₄₀]^{a-} anion; and
y is between 1 and 6, more preferably between 2 and 4, even more preferably between 3 and 4.

The high potential polyoxometallate for use in the present invention may also be represented by the formula:

H₃₊ₓM_{y-x}V_{y}Q_{12-y}ZO₄₀

wherein Z is selected from B, P, S, As, Si, Ge, Ni, Rh, Sn, Al, Cu, I, Br, F, Fe, Co, Cr, Zn, H₂, Te, Mn and Se and combinations of two or more thereof;
Q is selected Mo or W;
M is selected from the alkali metal ions;
x is between 0 and 4;
y is between 1 and 6, more preferably between 2 and 4, even more preferably between 3 and 4; and
y is greater than or equal to x.

Z is preferably phosphorus. Further, x is preferably between 0 and y and y is preferably between 2 and 4, or mixtures thereof. In a further embodiment, such a polyoxometallate is present at a concentration of up to around 0.6M by concentration of the central atom (Z), which is commonly phosphorus.

In another embodiment, the high potential polyoxometallate for use in the present invention may be represented by the formula:

HₐP_{c}MO_{y}VₓO_{b}

Wherein a is a number of H necessary to charge balance the [P_{c}Mo_{y}VₓO_{b}]^{a-} anion;
c is between 1 and 3;
y is between 8 and 20;
x is between 1 and 12; and
b is between 40 and 89.

Preferably, such a polyoxometallate has the formula H₁₂[P₃Mo₁₈V₇O₈₅], H₁₂[P₂Mo₁₂V₆O₈₂], H₁₄[P₂Mo₁₀V₈O₆₂] or H₁₅[P₃Mo₁₈V₆O₈₄].

In one preferred embodiment of the invention, the ion selective PEM is a cation selective membrane which is selective in favour of protons versus other cations.

The cation selective polymer electrolyte membrane may be formed from any suitable material, but preferably comprises a polymeric substrate having cation exchange capability. Suitable examples include fluororesin-type ion exchange resins and non-fluororesin-type ion exchange resins. Fluororesin-type ion exchange resins include perfluorocarboxylic acid resins, perfluorosulfonic acid resins, and the like. Perfluorocarboxylic acid resins are preferred, for example “Nafion” (Du Pont Inc.), “Flemion” (Asahi Gas Ltd), “Aciplex” (Asahi Kasei Inc) and the like. Non-fluororesin-type ion exchange resins include polyvinyl alcohols, polyalkylene oxides, styrene-divinylbenzene ion exchange resins and the like, and metal salts thereof. Preferred non-fluororesin-type ion exchange resins include polyalkylene oxide-alkali metal salt complexes. These are obtainable by polymerizing an ethylene oxide oligomer in the presence of lithium chlorate or another alkali metal salt, for example. Other examples include phenolsulphonic acid, polystyrene sulphonic, polytriflurostyrene sulphonic, sulphonated trifluorostyrene, sulphonated copolymers based on α,β,β triflurostyrene monomer and radiation-grafted membranes. Non-fluorinated membranes include sulphonated poly(phenylquinoxalines), poly (2,6 diphenyl-4-phenylene oxide), poly(arylether sulphone), poly(2,6-diphenylenol), acid-doped polybenzimidazole, sulphonated polyimides, styrene/ethylene-butadiene/styrene triblock copolymers, partially sulphonated polyarylene ether sulphone, partially sulphonated polyether ether ketone (PEEK) and polybenzyl suphonic acid siloxane (PBSS).

In some cases it may be desirable for the ion selective polymer electrolyte membrane to comprise a bimembrane. The bimembrane if present will generally comprise a first cation selective membrane and a second anion selective membrane. In this case the bimembrane may comprise an adjacent pairing of oppositely charge selective membranes. For example the bimembrane may comprise at least two discreet membranes which may be placed side-by-side with an optional gap therebetween. Preferably the size of the gap, if any, is kept to a minimum in the redox cell of the invention. The use of a bimembrane may be used in the redox battery of the invention to maximise the potential of the cell, by maintaining the potential due to a pH drop between the anode and catholyte solution. Without being limited by theory, in order for this potential to be maintained in the membrane system, at some point in the system, protons must be the dominant charge transfer vehicle. A single cation-selective membrane may not achieve this to the same extent due to the free movement of other cations from the catholyte solution in the membrane.

In this case, the cation selective membrane may be positioned on the cathode side of the bimembrane and the anion selective membrane may be positioned on the anode side of the bimembrane. In this case, the cation selective membrane is adapted to allow protons to pass through the membrane from the anode side to the cathode side thereof in operation of the cell. The anion selective membrane is adapted substantially to prevent cationic materials from passing therethrough from the cathode side to the anode side thereof, although in this case anionic materials may pass from the cathode side of the anionic-selective membrane to the anode side thereof, whereupon they may combine with protons passing through the membrane in the opposite direction. Preferably the anion selective membrane is selective for hydroxyl ions and combination with protons therefore yields water as a product.

In a second embodiment of the invention the cation selective membrane is positioned on the anode side of the bimembrane and the anion selective membrane is positioned on the cathode side of the bimembrane. In this case, the cation selective membrane is adapted to allow protons to pass through the membrane from the anode side to the cathode side thereof in operation of the cell. In this case, anions can pass from the cathode side into the interstitial space of the bimembrane and protons will pass from the anode side. It may be desirable in this case to provide means for flushing such protons and anionic materials from the interstitial space of the bimembrane. Such means may comprise one or more perforations in the cation selective membrane, allowing such flushing directly through the membrane. Alternatively, means may be provided for channelling flushed materials around the cation selective membrane from the interstitial space to the cathode side of the said membrane.

The redox battery of the present invention also operates at different current densities to those redox batteries of the prior art, which generally operate at between 50 and 100 mA/cm². In contrast, the redox battery of the present invention operates at a current density of at least 250 mA/cm², preferably at least 400 mA/cm² and more preferably 500 mA/cm².

A further aspect of the present invention provides the use of a polyoxometallate as described above as a redox couple in a redox battery. Also provided is a polyoxometallate as described above for use in a redox battery and a redox battery stack comprising the redox batteries as described above.

Various aspects of the present invention will now be more particularly described with reference to the following figures, which illustrate embodiments of the present invention:

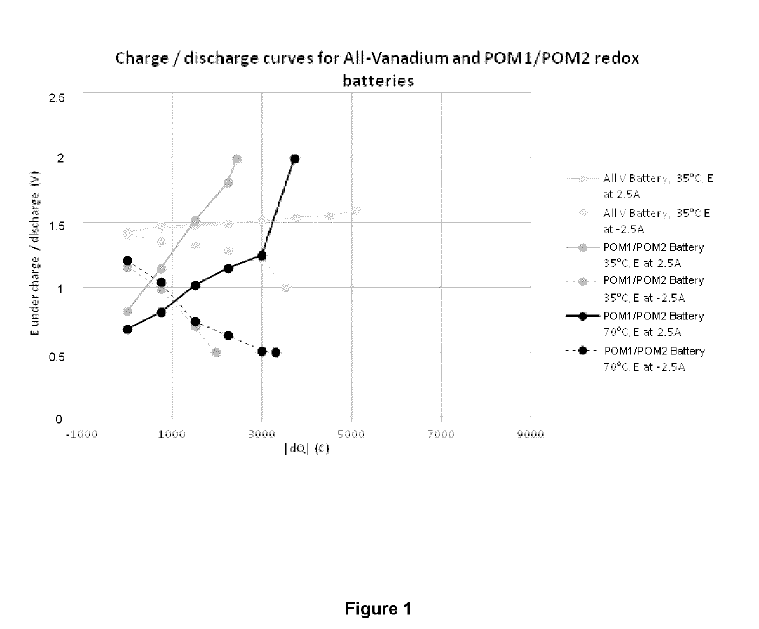

FIG. 1 demonstrates the voltage profiles for charge and discharge cycles using all-vanadium and POM1/POM2 polyoxometallate flow batteries;

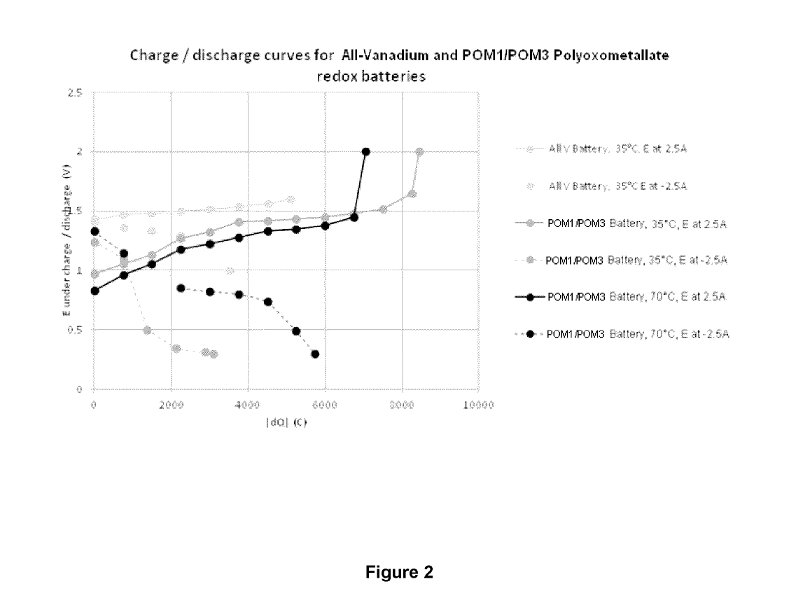

FIG. 2 demonstrates the voltage profiles for charge and discharge cycles using all-vanadium and POM1/POM3 polyoxometallate flow batteries;

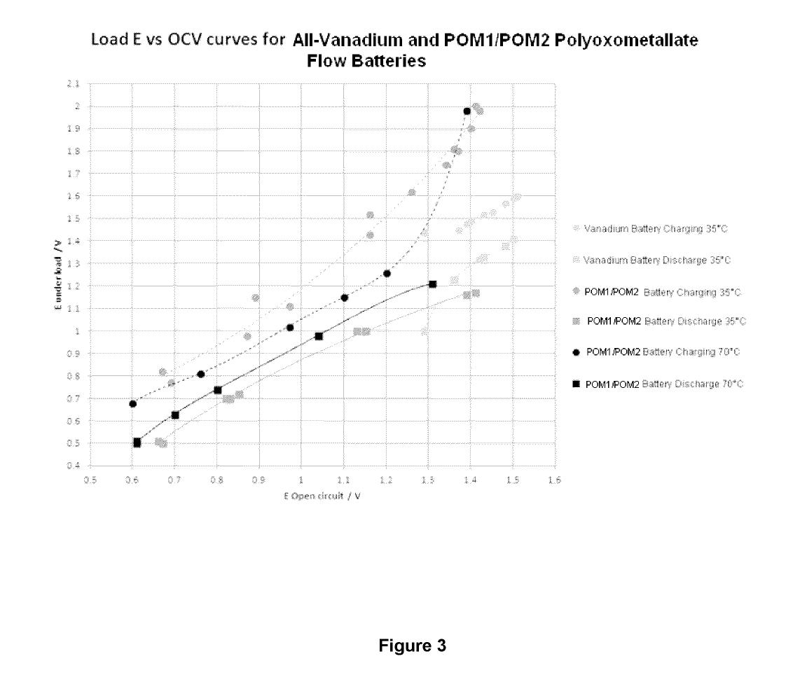

FIG. 3 demonstrates cell potential during charge and discharge vs. open circuit potential for all-vanadium and POM1/POM2 polyoxometallate flow batteries; and

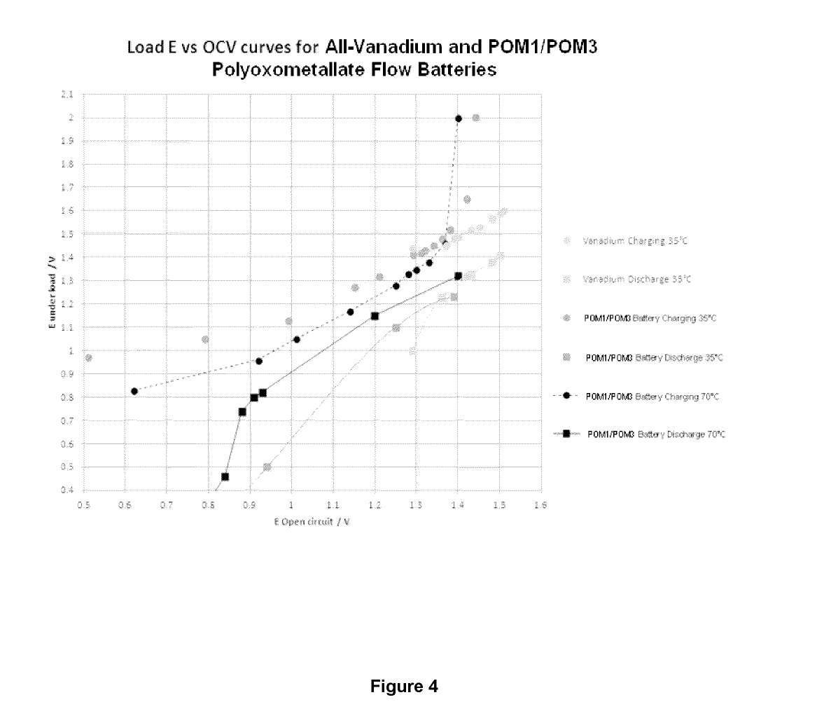

FIG. 4 demonstrates cell potential during charge and discharge vs. open circuit potential for all-vanadium and POM1/POM3 polyoxometallate flow batteries.

The data was obtained using a test stand with separate heated anolyte and catholyte reservoirs. A redox cell with 31 cm² active area was constructed using gold plated copper current collectors, stainless steel end plates, carbon anode and cathode blocks with plug-flow flow fields and silicone gaskets. Both anode and cathode electrodes were made from 2.5 mm GFD 2.5 carbon felt (SGL) that was compressed to 1.15 mm thickness. An NRE-212 membrane (Ion Power) was used to separate the anode and cathode. The anolyte and catholyte reservoirs were purged with nitrogen for 3 minutes before filling. 50 ml of anolyte and 100 ml of catholyte were measured out and poured into the respective reservoirs. The reservoirs were then purged with nitrogen every 10 minutes and were sealed whilst not being purged.

The battery was charged and discharged using a Bio-Logic potentiostat. Open circuit potential was also measured using this instrument.

Redox batteries were constructed and tested using: a) vanadium/sulphate+sulphuric acid solution as both anolyte and catholyte, b) silicotungstic acid as anolyte and Na₄H₃[Mo₈V₄PO₄₀] polyoxometallate as catholyte and c) silicotungstic acid as anolyte and H₁₀[P₂V₄Mo₈O₄₄] polyoxometallate as catholyte. The solutions used were:
1.6M vanadium and 4.0M SO₄ in ultra pure water (proton counter ions);
0.3M silicotungstic acid (2.4M tungsten 100% oxidised) in ultra pure water (POM1);
0.3M Na₄H₃[Mo₈V₄PO₄₀] (1.2M vanadium 50% oxidised) in ultra pure water (POM2); and
0.45M H₁₀[P₂V₄Mo₈O₄₄] (1.8M vanadium 50% oxidised) in ultra pure water (POM3).

A new cell was constructed for each different anolyte/catholyte combination. The cell catholyte and anolyte inlet pressure was maintained at 1000±150 mbar gauge. Cell, catholyte and anolyte temperatures were controlled at the same system temperature ±2° C. The current for all experiments was 2.50A or 80.6 mA/cm².

| | | | System | System |
|---|---|---|---|---|
| Experi- | | | temperature | temperature |
| ment | Anolyte | Catholyte | 1 (° C.) | 2 (° C.) |
| 1 | 1.8M vanadium | 1.8M vanadium | 35 | n/a |
| | and 4.0M SO₄ | and 4.0M SO₄ | | |
| 2 | 0.3M POM1 | 0.3M POM2 | 35 | 70 |
| 3 | 0.3M POM1 | 0.45M POM3 | 35 | 70 |

The performance of the vanadium/SO₄ flow battery was only assessed at 35° C. due to the limited solubility of V^{(V)} at temperatures above 40° C. The use of the polyoxometallate solution circumvents this solubility issue and therefore allows for the operation of the system at higher temperatures. Measurements were taken at 35 and 70° C. for at least one charge—discharge cycle at a high current density.

FIG. 1 demonstrates the voltage profiles for charge (solid lines) and discharge (dashed lines) cycles at 2.5 A (80.6 mA/cm²) using an all-vanadium flow battery at 35° C. and POM1/POM2 polyoxometallate flow batteries at 35 and 70° C. FIG. 2 demonstrates the voltage profiles for charge (solid lines) and discharge (dashed lines) cycles at 2.5 A (80.6 mA/cm²) using an all-vanadium flow battery at 35° C. and POM1/POM3 polyoxometallate flow batteries at 35 and 70° C.

FIGS. 1 and 2 demonstrate that the polyoxometallate flow batteries display E under load vs Q curves that are not unlike those expected for standard vanadium redox battery systems, although it is clear that the measured potential of the polyoxometallate batteries is lower than the vanadium systems. However, it is expected that the potential of the polyoxometallate battery can be raised by:
further reducing POM1; and/or
optimising the formulation of both catholyte and anolyte.

FIG. 3 demonstrates cell potential during charge (circles with dashed lines) and discharge (squares with solid lines) at 80.6 mA/cm² vs. open circuit potential for all-vanadium, POM1/POM2 polyoxometallate at 35° C. and POM1/POM2 polyoxometallate at 70° C. FIG. 4 demonstrates cell potential during charge (circles with dashed lines) and discharge (squares with solid lines) at 80.6 mA/cm² vs. open circuit potential for all-vanadium, POM1/POM3 polyoxometallate at 35° C. and POM1/POM3 polyoxometallate at 70° C.

FIGS. 3 and 4 demonstrate that the POM1/POM3 polyoxometallate battery has lower charging and discharging over-potential than the POM1/POM2 polyoxometallate battery. It is also apparent that for a portion of the open circuit range, the over-potential for the POM1/POM3 polyoxometallate battery is lower than that for the all-vanadium battery.

The coulombic efficiency has been calculated for all systems as:

$$Coulombic efficiency = \frac{Δ Qd}{Δ Qc}$$

### Where:

ΔQd=charge passed during discharge at 2.5 A from OCP=x to OCP=y
ΔQc=charge passed during charge at 2.5 A from OCP=y to OCP=x

| | | OCP y (V) | | | |
|---|---|---|---|---|---|
| Battery | OCP x (V) | (dis- | ΔQd | ΔQc | Coulombic |
| configuration | (charged) | charged) | (C) | (C) | efficiency |
| All V 35° C. | 1.5 | 1.29 | 3525 | 4350 | 80% |
| POM1/POM2 | 1.39 | 0.67 | 1975 | 2437.5 | 81% |
| 35° C. | | | | | |
| POM1/POM2 | 1.36 | 0.6 | 3300 | 3724.5 | 89% |
| 70° C. | | | | | |
| POM1/POM3 | 1.39 | 0.89 | 2125.5 | 6750 | 31% |
| 35° C. | | | | | |
| POM1/POM3 | 1.41 | 0.62 | 7050 | 5725.5 | 81% |
| 70° C. | | | | | |

This table demonstrates the calculated values for the coulombic efficiency of all redox battery systems tested in this series of experiments. It is apparent that the coulombic efficiencies of the polyoxometallate redox batteries were similar to that of the vanadium system at this high current density (the POM1/POM3 polyoxometallate at 35° C. result may be anomalous).

It is expected that the columbic and overall electrical efficiency advantage of the polyoxometallate systems will be clearer at higher operating current densities, as the electrode kinetics of the all-vanadium system are poorer than the polyoxometallate system. The voltage loss at higher current densities will therefore be higher for the all-vanadium system than for the polyoxometallate systems.

It is anticipated that the charge and discharge current density of the polyoxometallate flow batteries can be further increased (without loss of efficiency) by:
increasing the operating temperature above 70° C.;
optimising the formulation of catholyte and anolyte; and/or
improving the cell construction with for example thinner membranes or activated electrodes.

1. A redox battery comprising a polyoxometallate as at least one redox couple.

2. The redox battery according to claim 1 comprising two electrodes separated by an ion exchange membrane or other separator; means for supplying a first redox couple to the first electrode region of the cell; means for supplying a second redox couple to the second electrode region of the cell, the potential of the first redox couple being higher than that of the second redox couple, and at least the higher potential redox couple comprising polyoxometallate.

3. The redox battery according to claim 1 wherein the polyoxometallate is substantially rejected from the membrane or other separator by means of charge and/or size, so as to be substantially prevented from flowing through the ion exchange membrane or other separator.

4. The redox battery according to claim 3 wherein the large structure is a Keggin ion.

5. The redox battery according to claim 3 wherein the large structure is a bi-nuclear Dawson-Wells structure.

6. The redox battery according to claim 1 wherein at least the polyoxometallate redox couple is provided in aqueous solution.

7. The redox battery according to claim 1 wherein the current density of operation is significantly higher than the standard for a vanadium redox battery.

8. The redox battery according to claim 1 wherein the low potential redox couple comprises a tungsten polyoxometallate.

9. The redox battery according to claim 8 wherein the tungsten polyoxometallate has the structure HₓW₁₂KO₄₀, wherein K is for example, P, Si, B or Co, preferably Si, B or Co.

10. The redox battery according to claim 1 wherein the low potential redox couple comprises vanadium (II) and vanadium (III) ions.

11. The redox battery according to claim 1 wherein a non stoichiometric polyoxometallate solution is used.

12. The redox battery according to claim 1 wherein the polyoxometallate is present at a concentration of less than 0.075 M by the concentration of the central atom.

13. The redox battery according to claim 1 wherein the high potential polyoxometallate is a vanadium polyoxometallate.

14. The redox battery according to claim 1 wherein vanadium ions are added to the high potential polyoxometallate solution in the form of at least one vanadium compound selected from VO₂, V₂O₄, VOSO₄, VO(acac)₂, VO(ClO₄)₂, VO(BF₄)₂, hydrated versions thereof, and combinations of two or more thereof.

15. The redox battery according to claim 14, wherein the concentration of the vanadium compound is at least about 0.075M, at least about 0.5M, at least or equal to about 1M or equal to 2M.

16. The redox battery according to claim 14 or claim 15, wherein the molar ratio between the high potential polyoxometallate and the vanadium compound is at least about 1:10 or at least about 1.5:10 or at least about 2:10 or at least about 2.5:10 or at least about 3:10.

17. The redox battery according to claim 14, wherein VOSO₄ is added in the concentration range of 0.5 to 2M.

18. The redox battery according to claim 1 wherein the high potential polyoxometallate is represented by the formula:
Xₐ[Z_{b}M_{c}O_{d}]
wherein:
X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M is a metal selected from Mo, W, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series, and combinations of two or more thereof;
a is a number of X necessary to charge balance the [M_{c}O_{d}] anion;
b is from 0 to 20;
c is from 1 to 40; and
d is from 1 to 180.

19. The redox battery according to claim 1 wherein the high potential polyoxometallate is represented by the formula:
XₐV_{y}Q_{12-y}ZO₄₀
wherein:
X is selected from hydrogen, alkali metals, alkaline earth metals, ammonium and combinations of two or more thereof;
Q is selected Mo or W;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
a is a number of X necessary to charge balance the [V_{y}Q_{12-y}ZO₄₀]a⁻ anion; and
y is between 1 and 6.

20. The redox battery according to claim 19 wherein the high potential polyoxometallate is represented by the formula:
H₃₊ₓM_{y-x}V_{y}Q_{12-y}ZO₄₀
wherein
Z is selected from B, P, S, As, Si, Ge, Ni, Rh, Sn, Al, Cu, I, Br, F, Fe, Co, Cr, Zn, H₂, Te, Mn and Se and combinations of two or more thereof;
Q is selected Mo or W;
M is selected from the alkali metal ions;
x is between 0 and 4;
y is between 1 and 6, more preferably between 2 and 4, even more preferably between 3 and 4; and
y is greater than or equal to x.

21. The redox battery of claim 20 wherein x is between 0 and y and y is between 2 and 4.

22. The redox battery of claim 18 wherein Z is Phosphorus.

23. The redox battery of claim 18 wherein the polyoxometallate is present at a concentration of up to around 0.6M by concentration of the central atom (Z).

24. The redox battery according to claim 18 wherein the high potential polyoxometallate is represented by the formula:
HₐP_{c}Mo_{y}VₓO_{b}
wherein:
a is a number of H necessary to charge balance the [P_{c}Mo_{y}VₓO_{b}]^{a-} anion;
c is between 1 and 3;
y is between 8 and 20;
x is between 1 and 12; and
b is between 40 and 89.

25. The redox battery of claim 24 wherein the polyoxometallate is present at a concentration of up to around 0.6M by concentration of phosphorus.

26. The redox battery according to claim 24 wherein the polyoxometallate has the formula H₁₂[P₃Mo₁₈V₇O₈₅].

27. The redox battery according to claim 24 wherein the polyoxometallate has the formula H₁₂[P₂Mo₁₂V₆O₈₂].

28. The redox battery according to claim 24 wherein the polyoxometallate has the formula H₁₄[P₂Mo₁₀V₈O₆₂].

29. The redox battery according to claim 24 wherein the polyoxometallate has the formula H₁₅[P₃Mo₁₈V₆O₈₄].

30. The redox battery of claim 1, wherein the current density is at least 250 mA/cm², preferably at least 400 mA/cm² and more preferably 500 mA/cm².

31. A redox couple in a redox battery comprising the polyoxometallate according to claim 1.

32. A polyoxometallate for use in the redox battery of claim 1.

33. A redox battery stack comprising the redox batteries according to claim 1.

34. The redox battery of claim 19 wherein Z is Phosphorus.

35. The redox battery of claim 19 wherein the polyoxometallate is present at a concentration of up to around 0.6M by concentration of the central atom (Z).

36. Currently amended) The redox battery according to claim 19 wherein the high potential polyoxometallate is represented by the formula:
HₐP_{c}Mo_{y}VₓO_{b}
Wherein:
a is a number of H necessary to charge balance the [P_{c}Mo_{y}VₓO_{b}]^{a-} anion;
c is between 1 and 3;
y is between 8 and 20;
x is between 1 and 12; and
b is between 40 and 89.

37. The redox battery of claim 36 wherein the polyoxometallate is present at a concentration of up to around 0.6M by concentration of phosphorus.

38. The redox battery according to claim 36 wherein the polyoxometallate has the formula H₁₂[P₃Mo₁₈V₇O₈₅].

39. The redox battery according to claim 36 wherein the polyoxometallate has the formula H₁₂[P₂Mo₁₂V₆O₈₂].

40. The redox battery according to claim 36 wherein the polyoxometallate has the formula H₁₄[P₂Mo₁₀V₈O₆₂].

41. The redox battery according to claim 36 wherein the polyoxometallate has the formula H₁₅[P₃Mo₁₈V₆O₈₄].
